(19) United States
(12) Patent Application Publication
(10) Pub. No.: US 2025/0119460 A1
(43) Pub. Date: Apr. 10, 2025

(54) SERVICE-BASED ARCHITECTURE FOR PROVIDING A DATA CHANNEL ASSOCIATED WITH AN INTERNET PROTOCOL MULTIMEDIA SUBSYSTEM

(71) Applicant: QUALCOMM Incorporated, San Diego, CA (US)

(72) Inventors: Kefeng ZHANG, Beijing (CN); Haris ZISIMOPOULOS, London (GB); Sebastian SPEICHER, Wallisellen (CH)

(21) Appl. No.: 18/832,294

(22) PCT Filed: Mar. 24, 2022
(86) PCT No.: PCT/CN2022/082707

§ 371 Date: Jul. 23, 2024

(51) Int. Cl. H04L 65/1069; H04L 65/1016

(52) U.S. Cl. CPC H04L 65/1069; H04L 65/1016

(57) ABSTRACT

Various aspects of the present disclosure generally relate to wireless communication. In some aspects, an apparatus at a network node of an internet protocol multimedia subsystem may receive a data channel resource request comprising session description protocol information corresponding to a multimedia call session between a first user equipment and a second user equipment, the data channel resource request indicating media description information associated with the multimedia call session. The apparatus may allocate, based at least in part on the session description protocol information, data channel resources corresponding to at least one data channel and associated with the first user equipment and the second user equipment. The apparatus may provide, using the at least one data channel, a first data channel application to the first user equipment and a second data channel application to the second user equipment. Numerous other aspects are described.

### FIELD OF THE DISCLOSURE

Aspects of the present disclosure generally relate to an internet protocol multimedia subsystem (IMS) and, for example, to a service-based architecture for providing a data channel associated with an IMS.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful. Some of those improvements involve improvements to services that facilitate communications between network nodes associated with a telecommunication network such as, for example, internet protocol multimedia subsystems (IMSs). IMSs facilitate multimedia content transmission, reception, and delivery through a network.

### SUMMARY

Some aspects described herein relate to an apparatus for wireless communication at a network node. The apparatus may include a memory and one or more processors coupled to the memory. The one or more processors may be configured to receive a data channel resource request comprising session description protocol information corresponding to a multimedia call session between a first user equipment and a second user equipment. The data channel resource request may indicate media description information associated with the multimedia call session. The one or more processors may be further configured to allocate, based at least in part on the session description protocol information, data channel resources corresponding to at least one data channel and associated with the first user equipment and the second user equipment and provide, using the at least one data channel, a first data channel application to the first user equipment and a second data channel application to the second user equipment.

Some aspects described herein relate to an apparatus for wireless communication at a network node. The apparatus may include a memory and one or more processors coupled to the memory. The one or more processors may be configured to receive, from a first user equipment, an initial session description protocol offer comprising session description protocol information corresponding to a multimedia call session between the first user equipment and a second user equipment. The initial session description protocol offer may indicate media description information associated with the multimedia call session. The one or more processors may be further configured to transmit a data channel resource request that indicates the media description information.

Some aspects described herein relate to a method of communication performed by a network node. The method may include receiving a data channel resource request comprising session description protocol information corresponding to a multimedia call session between a first user equipment and a second user equipment. The data channel resource request may indicate media description information associated with the multimedia call session. The method may further include allocating, based at least in part on the session description protocol information, data channel resources corresponding to at least one data channel and associated with the first user equipment and the second user equipment and providing, using the at least one data channel, a first data channel application to the first user equipment and a second data channel application to the second user equipment.

Some aspects described herein relate to a method of communication performed by a network node. The method may include receiving, from a first user equipment, an initial session description protocol offer comprising session description protocol information corresponding to a multimedia call session between the first user equipment and a second user equipment. The initial session description protocol offer may indicate media description information associated with the multimedia call session. The method may further include transmitting a data channel resource request that indicates the media description information.

Some aspects described herein relate to a non-transitory computer-readable medium storing a set of instructions for wireless communication. The set of instructions may include one or more instructions that, when executed by one or more processors of a network node, cause the network node to receive a data channel resource request comprising session description protocol information corresponding to a multimedia call session between a first user equipment and a second user equipment. The data channel resource request may indicate media description information associated with the multimedia call session. The one or more instructions may further cause the network node to allocate, based at least in part on the session description protocol information, data channel resources corresponding to at least one data channel and associated with the first user equipment and the second user equipment and provide, using the at least one data channel, a first data channel application to the first user equipment and a second data channel application to the second user equipment.

Some aspects described herein relate to a non-transitory computer-readable medium storing a set of instructions for wireless communication. The set of instructions may include one or more instructions that, when executed by one or more processors of a network node, cause the network node to receive, from a first user equipment, an initial session description protocol offer comprising session description protocol information corresponding to a multimedia call session between the first user equipment and a second user equipment. The initial session description protocol offer may indicate media description information associated with the multimedia call session. The one or more instructions may further cause the network node to transmit a data channel resource request that indicates the media description information.

Some aspects described herein relate to an apparatus for wireless communication. The apparatus may include means for receiving a data channel resource request comprising session description protocol information corresponding to a multimedia call session between a first user equipment and a second user equipment. The data channel resource request may indicate media description information associated with the multimedia call session. The apparatus may further include means for allocating, based at least in part on the session description protocol information, data channel resources corresponding to at least one data channel and associated with the first user equipment and the second user equipment and means for providing, using the at least one data channel, a first data channel application to the first user equipment and a second data channel application to the second user equipment.

Some aspects described herein relate to an apparatus for wireless communication. The apparatus may include means for receiving, from a first user equipment, an initial session description protocol offer comprising session description protocol information corresponding to a multimedia call session between the first user equipment and a second user equipment. The initial session description protocol offer may indicate media description information associated with the multimedia call session. The apparatus may further include means for transmitting a data channel resource request that indicates the media description information.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example system 100 in which devices and/or methods described herein may be implemented, in accordance with the present disclosure.

FIG. 2 is a diagram of example components of an apparatus, in accordance with the present disclosure.

FIG. 3 is a diagram illustrating an example 300 of a service-based architecture for providing a data channel associated with an internet protocol multimedia subsystem (IMS), in accordance with the present disclosure.

FIG. 4 is a diagram illustrating an example 400 associated with a service-based architecture for providing a data channel associated with an IMS, in accordance with the present disclosure.

FIGS. 5 and 6 are flowcharts of example processes associated with a service-based architecture for providing a data channel associated with an IMS, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

An Internet protocol multimedia subsystem (IMS) architecture facilitates development and deployment of multiple types of multimedia services. Some considerations addressed by IMSs include interoperability, end-to-end service, and security. IMS has been positioned on top of network layers to make it access and device independent that is, IMS services may be implemented on a variety of different end user devices, including mobile phones, personal computers, set top boxes, and/or modems, among other examples.

The IMS architecture allows operators to offer carrier grade services to be offered on packet-switched networks. Examples of services that have been standardized on top of IMS include Open Mobile Alliance (OMA) presence and group list management, Push-to-Talk over Cellular (PoC), Instant Messaging, and TISPAN/3GPP multimedia telephony for IMS (MMTel). Other IMS services that have been developed for deployment as next-generation LTE services include Voice over LTE (VoLTE) and Video Telephony (VT). Services such as VoLTE may be particularly beneficial by allowing a device to camp on LTE service for both voice and data communications, instead of requiring a switch or fallback to a circuit-switched network.

Other applications have been developed that provide carrier grade data services controlled by operators. For example, the Rich Communications Suite (RCS) is an applications suite that provides carrier grade video and file sharing, instant messaging, and other data applications using IP-based solutions that are compatible across devices and networks. For example, enhanced messaging services generally provide a large number of messaging options including chat, location sharing, and file sharing, and enhanced calling services generally provide multimedia content sharing during a voice call, and video calling.

Data channels may be integrated into IMS calls; however, conventional IMS architecture does not include components for integrating data channels. Some aspects of techniques and apparatuses described herein facilitate integration of data channels into IMS calls based on service-based architectures to support the functionalities of the data channel. Network functions specified for data channel management may include a Data Channel Server (DChS) and a Data Channel Application Repository (DCAR). Network functions also may include data channel interfaces to facilitate data channel functionality. In this way, some aspects may support integration of data channels in IMS session calls, thereby improving the offerings of wireless communications and having a positive impact on network performance.

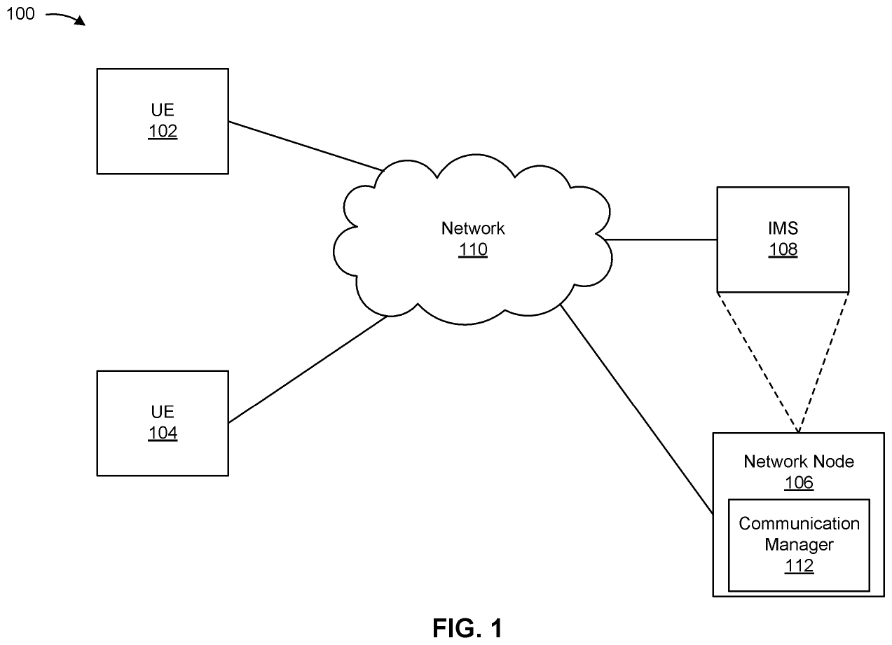

FIG. 1 is a diagram illustrating an example system 100 in which devices and/or methods described herein may be implemented, in accordance with various aspects of the present disclosure. As shown in FIG. 1, system 100 may include a first user equipment (UE) 102, a second UE 104, a network node 106 that provides one or more components of an internet protocol (IP) multimedia subsystem (IMS) 108, and a network 110. Devices of system 100 may interconnect via wired connections, wireless connections, or a combination of wired and wireless connections.

The network 100 may include, for example, a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. In some aspects, the network 110 may include a data network and/or be communicatively communicatively with a data platform (e.g., a web-platform, a cloud-based platform, a non-cloud-based platform, and/or the like) that is capable of receiving, generating, processing, and/or providing information associated with a data channel, as described herein.

In general, any number of networks 100 may be deployed in a given geographic area. Each network 100 may support a particular radio access technology (RAT) and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, New Radio (NR) or 5G RAT networks may be deployed.

The UEs 102 and 104 may be dispersed throughout a network 100, and each UE 102 and/or 104 may be stationary or mobile. A UE 102 and/or 104 may include, for example, an access terminal, a terminal, a mobile station, and/or a subscriber unit. A UE 102 and/or 104 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

In some aspects, for example, the UE 102 and/or 104 may be one or more devices configured to communicate with one another by transmitting and receiving multimedia communications, as described herein. The network node 106 may include one or more devices capable of receiving, generating, storing, processing, and/or providing information associated with one or more IMS functions, as described herein. For example, the network node 106 may include one or more server nodes, one or more server functions, and/or one or more data repository functions. As shown, the network node 106 may include a communication manager 112 configured to perform one or more communication tasks as described herein.

For example, as described in more detail elsewhere herein, the communication manager 112 may receive a data channel resource request comprising session description protocol information corresponding to a multimedia call session between a first user equipment and a second user equipment, the data channel resource request indicating media description information associated with the multimedia call session; allocate, based at least in part on the session description protocol information, data channel resources corresponding to at least one data channel and associated with the first user equipment and the second user equipment; and provide, using the at least one data channel, a first data channel application to the first user equipment and a second data channel application to the second user equipment.

In some aspects, the communication manager 112 may receive, from a first user equipment, an initial session description protocol offer comprising session description protocol information corresponding to a multimedia call session between the first user equipment and a second user equipment, the initial session description protocol offer indicating media description information associated with the multimedia call session; and transmit a data channel resource request that indicates the media description information. Additionally, or alternatively, the communication manager 240 may perform one or more other operations described herein.

The number and arrangement of devices and networks shown in FIG. 1 are provided as one or more examples. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of system 100 may perform one or more functions described as being performed by another set of devices of system 100.

As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

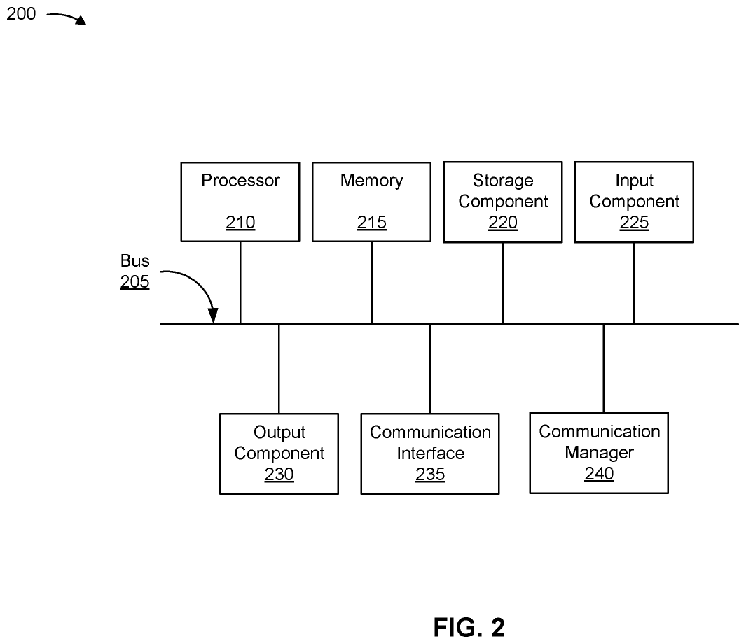

FIG. 2 is a diagram of example components of an apparatus 200. Apparatus 200 may correspond to the UE 102, the UE 104, and/or the network node 106. Additionally, or alternatively, the network node 102, the network node 104, and/or the network node 106 may include one or more apparatuses 200 and/or one or more components of apparatus 200. For example, in some aspects, apparatus 200 may include an apparatus (e.g., a device, a device component, a modem, a chip, and/or a set of device components, among other examples) that is configured to perform a wireless communication method at a network node, as described herein. As shown in FIG. 2, apparatus 200 may include a bus 205, a processor 210, a memory 215, a storage component 220, an input component 225, an output component 230, a communication interface 235, and a communication manager 240.

Bus 205 includes a component that permits communication among the components of apparatus 200. Processor 210 includes a central processing unit (CPU), a graphics processing unit (GPU), an accelerated processing unit (APU), a digital signal processor (DSP), a microprocessor, a microcontroller, a field-programmable gate array (FPGA), an application-specific integrated circuit (ASIC), and/or another type of processing component. Processor 210 is implemented in hardware, firmware, or a combination of hardware and software. In some aspects, processor 210 includes one or more processors capable of being programmed to perform a function.

Memory 215 includes a random-access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of apparatus 200. For example, storage component 220 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits apparatus 200 to receive information, such as via user input. For example, input component 225 may be associated with a user interface as described herein (e.g., to permit a user to interact with the one or more features of apparatus 200). Input component 225 includes a capacitive touchscreen display that can receive user inputs. Input component 225 may include a keyboard, a keypad, a mouse, a button, a switch, a microphone, and/or the like. Additionally, or alternatively, input component 225 may include a sensor for sensing information (e.g., a vision sensor, a location sensor, an accelerometer, a gyroscope, an actuator, and/or the like). In some aspects, input component 225 may include a camera (e.g., a high-resolution camera, a low-resolution camera, and/or the like). Output component 230 includes a component that provides output from apparatus 200 (e.g., a display, a speaker, one or more light-emitting diodes (LEDs), and/or the like).

Communication interface 235 includes a transceiver and/or a separate receiver and transmitter that enables apparatus 200 to communicate with other devices, such as via a wired connection, a wireless connection, or a combination of wired and wireless connections. Communication interface 235 may permit apparatus 200 to receive information from another device and/or provide information to another device. For example, communication interface 235 may include an Ethernet interface, an optical interface, a coaxial interface, an infrared interface, a radio frequency (RF) interface, a universal serial bus (USB) interface, a Wi-Fi interface, a cellular network interface, a wireless modem, an inter-integrated circuit (I²C), a serial peripheral interface (SPI), or the like.

Communication manager 240 may include hardware, software, or a combination of hardware and software configured to cause apparatus 200 to perform one or more service-based communication tasks associated with an IMS. In some aspects, communication manager 240 may be, be similar to, include, or be included in, the communication manager 112 depicted in FIG. 1. For example, communication manager 240 may facilitate communication resource allocation, data channel management, data traffic routing, session description protocol offer generation, and/or other tasks associated with establishing and/or maintaining a bootstrap data channel within an IMS. In some aspects, communication manager 240 may include one or more of processor 210, memory 215, storage component 220, input component 225, output component 230, and communication interface 235, and/or one or more aspects thereof.

In some aspects, the apparatus 200 includes means for receiving a data channel resource request comprising session description protocol information corresponding to a multimedia call session between a first user equipment and a second user equipment, the data channel resource request indicating media description information associated with the multimedia call session; means for allocating, based at least in part on the session description protocol information, data channel resources corresponding to at least one data channel and associated with the first user equipment and the second user equipment; and/or means for providing, using the at least one data channel, a first data channel application to the first user equipment and a second data channel application to the second user equipment.

In some aspects, the apparatus 200 includes means for receiving, from a first user equipment, an initial session description protocol offer comprising session description protocol information corresponding to a multimedia call session between the first user equipment and a second user equipment, the initial session description protocol offer indicating media description information associated with the multimedia call session; and/or means for transmitting a data channel resource request that indicates the media description information. In some aspects, the means for the apparatus 200 to perform operations described herein may include, for example, one or more of processor 210, memory 215, storage component 220, input component 225, output component 230, communication interface 235, or communication manager 240.

As indicated above, FIG. 2 is provided as an example. Other examples may differ from what is described with regard to FIG. 2.

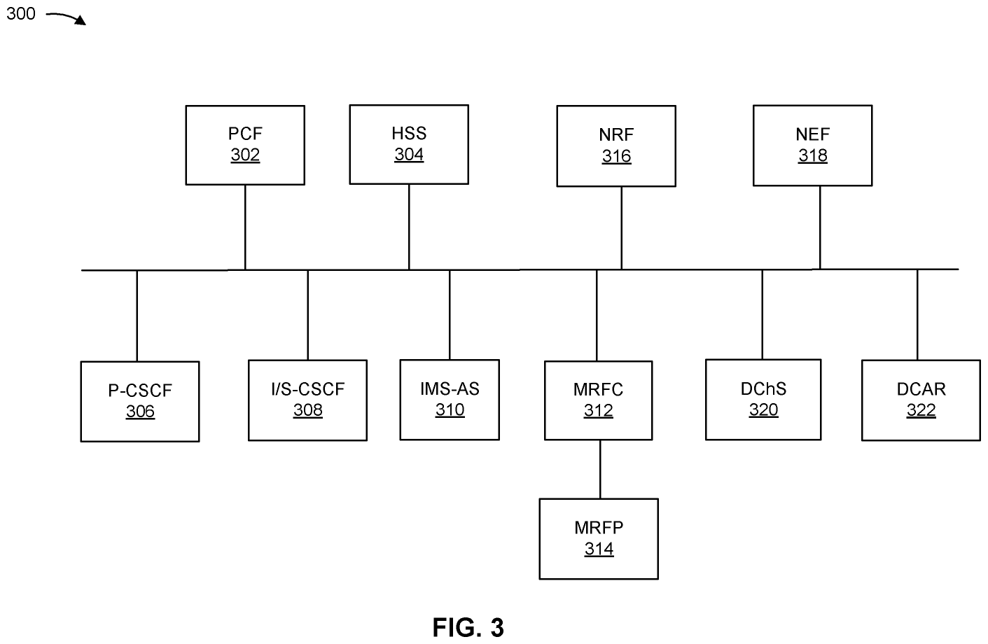

FIG. 3 is a diagram illustrating an example 300 of a service-based architecture for providing a data channel associated with an IMS, in accordance with the present disclosure. As shown in FIG. 3, example 300 includes a policy control function (PCF) 302, a home subscriber service (HSS) 304, a proxy-call session control function (P-CSCF) 306, an interrogating/serving (I/S)-CSCF 308, an IMS-application server (IMS-AS) 310, a media resource function controller (MRFC) 312, and a media resource function processor (MRFP) 314. The example 300 also includes a network repository function (NRF) 316, a network exposure function (NEF) 318, a data channel server (DChS) 320, and a data channel application repository (DCAR) 322. In some aspects, the NEF 316 and the NEF 318 may be 5G core network functions that include a data channel interface to the IMS of example 300.

The PCF 302 may facilitate access to a wireless telecommunications network by the IMS and may manage network policy compliance associated with the interface between the wireless telecommunications network and the IMS. The HSS 304 may maintain and manage an IMS user profile associated with a UE (e.g., the UE 102 and/or 104). The P-CSCF 306 is a session initiation protocol (SIP) proxy that may provide an interface between the IMS and a UE (e.g., the UE 102 and/or 104). The P-CSCF provides subscriber authentication and may establish security protocols with respect to the IMS. The I/S-CSCF 308 may include an interrogation function that queries the HSS 304 to obtain an address for a serving CSCF function of the I/S-CSCF 308 and may assign the address to a UE registering with the IMS. The serving CSCF function of the I/S-CSCF 308 is a SIP server and also may perform session control. The serving CSCF function of the I/S-CSCF 308 may facilitate managing SIP registrations, provide routing and enforce IMS and/or network policies.

The IMS-AS 310 hosts and executes IMS services. The IMS-AS 310 may interface with the I/S-CSCF 308 using SIP. The MRFC 312 and the MRFP 314 form a media resource function (MRF) that provides media functions such as media manipulation, video and audio mixing, and/or other application-based media services. The MRFC 312 is a signaling plane IMS node that may interpret information received from the IMS-AS 310 and/or the I/S-CSCF 308 to control the MRFP 314. The MRFC 312 may include a service-based interface to support the handling of media data from data channels and convergence of the media data with audio and/or video traffic in the media channels. The MRFP 314 is a media plane IMS node that may be used to source, combine, and/or otherwise process media streams.

The NRF 316 and the NEF 318 may be network functions that include communication interfaces that enable the NRF 316 and the NEF 318 to communicate using a data channel, as described herein. In some aspects, the MRFC 312 also may include a communication interface that enables the RFC 312 to communicate using the data channel. The NRF 316 may maintain a list of available network functions instances and associated profiles. The NRF 316 also may support a service discovery function associated with the IMS. In some aspects, the NEF 318 may expose services and resources inside and outside of the wireless telecommunications network core. The NEF 318 may support provision of external information to the IMS. In some aspects, for example, the NEF 318 may support provision of data channel applications to the IMS network.

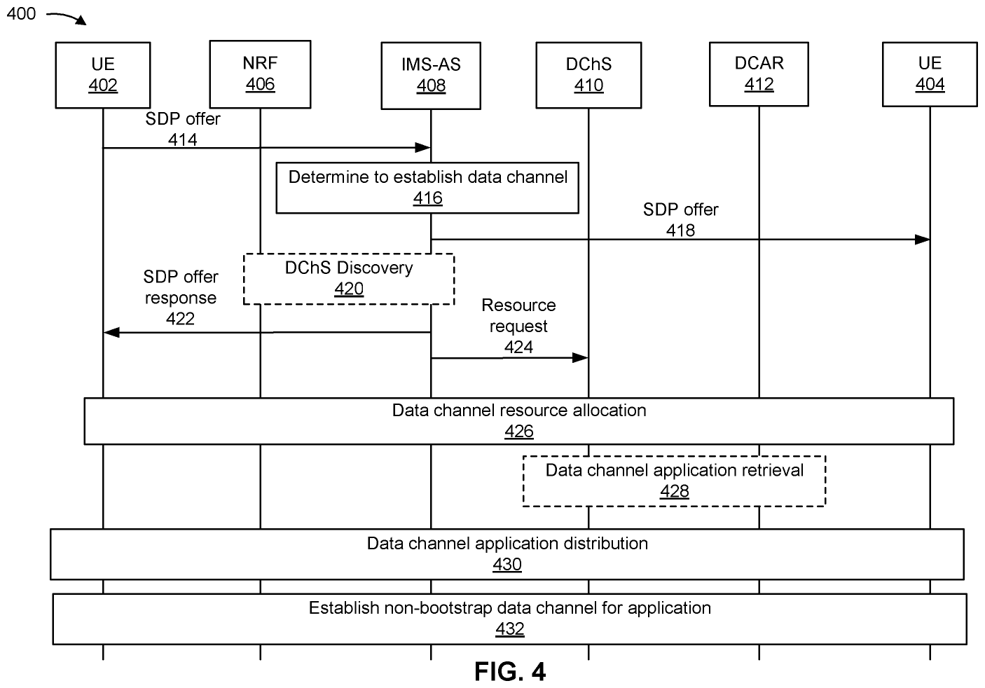

The DChS 320 may receive data channel applications from UEs and/or other otherized entities and may store the data channel applications in the DCAR 322. The DChS 320 may manage data channels with data-channel-capable multimedia telephony service for IMS (DCMTSI) clients according to requests from the IMS-AS 310. For example, in some aspects, the UE 102 and the UE 104 may include DCMTSI clients. The DChS 320 may distribute data channel applications and/or data channel application updates to DCMTSI clients (e.g., the UE 102 and/or 104) and may route data channel application traffic between the DCMTSI clients and application servers. In some aspects, the DChS 320 may generate data channel traffic usage reports and data channel event reports to facilitate management of the data channel. The DCAR 322 is a repository that may store and retrieve data channel applications. By integrating data channel related functions associated with one or more of the NRF 316, the NEF 318, the MRFC 312, the DChS 320, and the DCAR 322 in the IMS architecture, some aspects may facilitate data channel use within an IMS, as described in further detail below with respect to FIG. 4.

As indicated above, FIG. 3 is provided as an example. Other examples may differ from what is described with respect to FIG. 3.

FIG. 4 is a diagram illustrating an example 400 associated with a service-based architecture for providing a data channel associated with an IMS, in accordance with the present disclosure. As shown in FIG. 4, example 400 includes a UE 402 that communicates with a UE 404. The UE 402 and UE 404 may communicate using a multimedia call (e.g., a video call) via an IMS such as, for example, an IMS having one or more aspects of the IMS architecture depicted in example 300 of FIG. 3. The UE 402 and/or the UE 404 may be, be similar to, include, or be included in, the UE 102 and/or the UE 104 depicted in FIG. 1.

As shown, example 400 also includes an NRF 406, an IMS-AS 408, a DChS 410, and a DCAR 412, each of which may be referred to as a “network node.” The NRF 406 may be, be similar to, include, or be included in, the NRF 316 depicted in FIG. 3. The IMS-AS 408 may be, be similar to, include, or be included in, the IMS-AS 310 depicted in FIG. 3. The DChS 410 may be, be similar to, include, or be included in, the DChS 320 depicted in FIG. 3. The DCAR 412 may be, be similar to, include, or be included in, the DCAR 322 depicted in FIG. 3.

As shown by reference number 414, the UE 402 (which may be referred to as the “originating UE”) may transmit, and the IMS-AS 408 may receive, an initial session description protocol (SDP) offer for a data channel that includes a data channel media description for one or more bootstrap data channels. A bootstrap data channel is a data channel that is established based at least in part on session description protocol information. The session description protocol information includes authentication information so that the bootstrap data channel can be used to distribute update data channel applications (and/or application updates) to a UE associated with the authentication information. In some aspects, the initial SDP offer for the data channel may be carried with an audio/video media description in an IMS session establishment communication. In some aspects, the initial SDP offer for the data channel may be carried in a separate invite request after an audio/video media channel is established successfully.

As shown by reference number 416, the IMS-AS 408 may determine to establish a bootstrap data channel. The IMS-AS 408 may determine to establish the bootstrap data channel based at least in part on UE subscription information and/or a network operator policy. As shown by reference number 418, the IMS-AS 408 may transmit an SDP offer to the UE 404 to establish another bootstrap data channel between the DChS 410 and the UE 404 (which may be referred to as the “terminating UE”). In some aspects, the UE 404 may transmit a response to the IMS-AS 408, indicating acceptance of the SDP offer.

As shown by reference number 420, in some aspects, the IMS-AS 408 may perform a DChS discovery process, using the NRF 406. For example, the IMS-AS 408 may identify a data channel server instance based at least in part on performing the data channel server discovery process. The IMS-AS 408 may perform the data channel server discovery process based at least in part on receiving an indication of the data channel server instance from the NRF 406. In some aspects, the NRF 406 includes a network function profile associated with the IMS. As shown by reference number 422, the IMS-AS 408 may transmit an SDP offer response to the UE 402, indicating an acceptance of the initial SDP offer.

In some aspects, as shown by reference number 424, the IMS-AS 408 may transmit, and the DChS 410 may receive, a data channel resource request (shown as “resource request”) for the DChS 410 to allocate resources for the bootstrap data channel. The data channel resource request may include SDP information corresponding to a multimedia call session between the UE 402 and the UE 404. The data channel resource request may indicate media description information associated with the multimedia call session.

As shown by reference number 426, the DChS 410 may allocate resources corresponding to at least one data channel and associated with the UE 402 and the UE 404. The at least one data channel may include at least one bootstrap data channel. For example, the DChS 410 may reserve, based at least in part on the SDP information, data channel resources corresponding to at least one data channel and associated with the UE 402 and the UE 404. For example, the DChS 410 may reserve resources for a bootstrap data channel between the DChS 410 and the UE 402. Upon receiving an SDP response from the UE 404 (e.g., in response to the SDP offer sent to the UE 404), the DChS may allocate bearer resources for the bootstrap data channel between the DChS 410 and the UE 404. The allocated resources may include at least one of a datagram transport layer security protocol bearer or a stream control transmission protocol bearer.

As shown by reference number 428, the DChS 410 may retrieve at least one of a first data channel application or a second data channel application from the DCAR 412. In some aspects, the DChS 410 may receive at least one of the first data channel application or the second data channel application and store the at least one of the first data channel application or the second data channel application in the DCAR 412 prior to retrieving the at least one of the first or second data channel applications.

As shown by reference number 430, the data channel applications are distributed. For example, in some aspects, the DChS 410 may provide, using the at least one data channel, the first data channel application to the UE 402 and the second data channel application to the UE 404. In some aspects, for example, the first data channel application may be a first instance of a data channel application and the second data channel application may be a second instance of the data channel application. In this way, the UE 402 and the UE 404 may each include an instance of the same data channel application, enabling communication between the UE 402 and the UE 404 using the two instances of the data channel application. In some aspects, the UE 404 may reject the bootstrap data channel SDP offer and the DChS 410 may provide a data channel application only to the UE 402. In some aspects, the DChS 410 may provide, using the data channel, a data channel application update to the UE 402 and/or the UE 404. In some aspects, as shown by reference number 432, one or more non-bootstrap data channels may be established according to media features of the applications.

As indicated above, FIG. 4 is provided as an example. Other examples may differ from what is described with respect to FIG. 4.

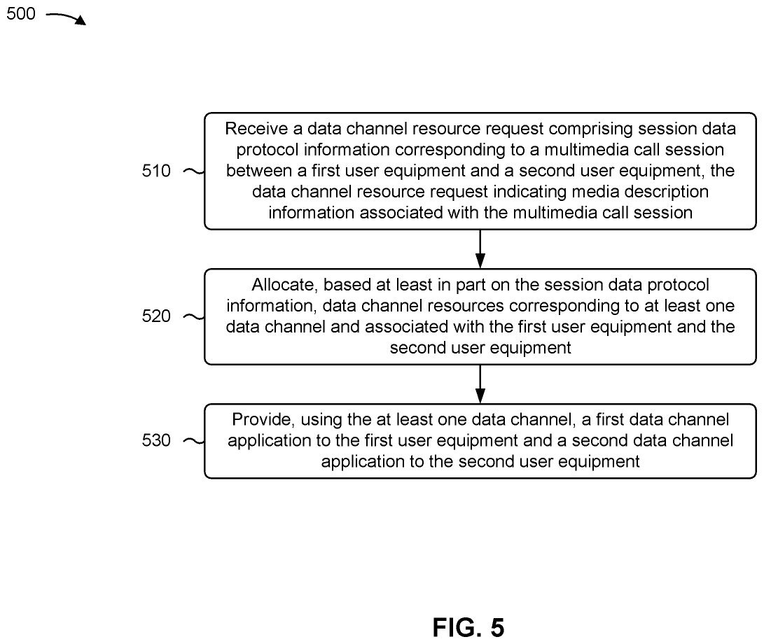

FIG. 5 is a flowchart of an example process 500 associated with a service-based architecture for providing a data channel associated with an IMS. In some implementations, one or more process blocks of FIG. 5 are performed by an apparatus (e.g., apparatus 200) at a network node (e.g., DChS 410). In some implementations, one or more process blocks of FIG. 5 are performed by another device or a group of devices separate from or including the apparatus. Additionally, or alternatively, one or more process blocks of FIG. 5 may be performed by one or more components of apparatus 200, such as processor 210, memory 215, storage component 220, input component 225, output component 230, communication interface 235, or communication manager 240.

As shown in FIG. 5, process 500 may include receiving a data channel resource request comprising session description protocol information corresponding to a multimedia call session between a first user equipment and a second user equipment, the data channel resource request indicating media description information associated with the multimedia call session (block 510). For example, the apparatus may receive a data channel resource request comprising session description protocol information corresponding to a multimedia call session between a first user equipment and a second user equipment, the data channel resource request indicating media description information associated with the multimedia call session, as described above.

As further shown in FIG. 5, process 500 may include allocating, based at least in part on the session description protocol information, data channel resources corresponding to at least one data channel and associated with the first user equipment and the second user equipment (block 520). For example, the apparatus may allocate, based at least in part on the session description protocol information, data channel resources corresponding to at least one data channel and associated with the first user equipment and the second user equipment, as described above.

As further shown in FIG. 5, process 500 may include providing, using the at least one data channel, a first data channel application to the first user equipment and a second data channel application to the second user equipment (block 530). For example, the apparatus may provide, using the at least one data channel, a first data channel application to the first user equipment and a second data channel application to the second user equipment, as described above.

Process 500 may include additional implementations, such as any single implementation or any combination of implementations described below and/or in connection with one or more other processes described elsewhere herein.

With respect to process 500, in some aspects, the data channel resources comprise at least one bearer.

With respect to process 500, in some aspects, the at least one bearer comprises at least one of a datagram transport layer security protocol bearer or a stream control transmission protocol bearer.

In some aspects, process 500 includes receiving at least one of the first data channel application or the second data channel application, and storing the at least one of the first data channel application or the second data channel application in a data channel application repository.

In some aspects, process 500 includes retrieving at least one of the first data channel application or the second data channel application from a data channel application repository.

In some aspects, process 500 includes providing, using the data channel, a data channel application update to the user equipment.

In some aspects, process 500 includes routing data channel application traffic, associated with at least one of the first data channel application or the second data channel application, between at least one of the first user equipment or the second user equipment and at least one application server instance.

In some aspects, process 500 includes generating one or more reports that indicate at least one parameter value, wherein the at least one parameter value corresponds to at least one of usage traffic associated with at least one of the first data channel application or the second data channel application, or an occurrence of an event associated with the data channel application.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

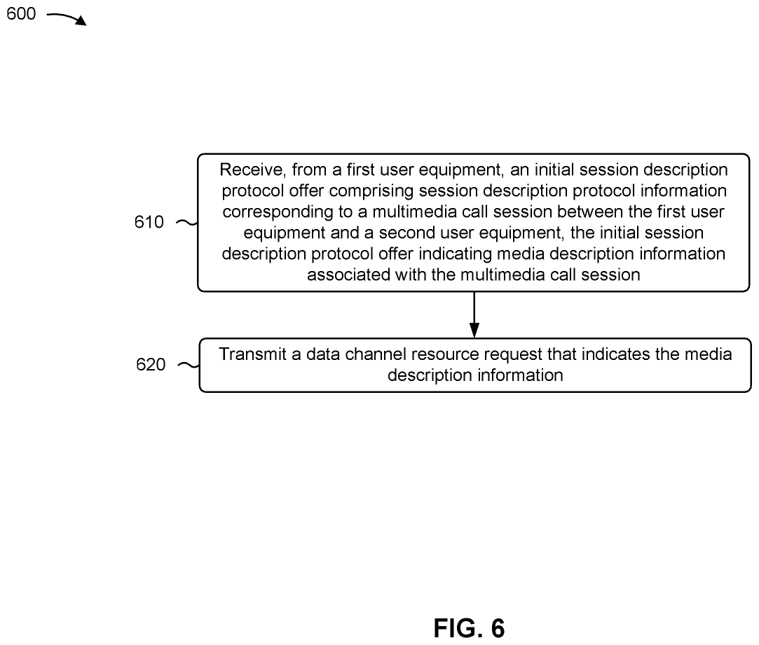

FIG. 6 is a flowchart of an example process 600 associated with a service-based architecture for providing a data channel associated with an IMS. In some implementations, one or more process blocks of FIG. 6 are performed by an apparatus (e.g., apparatus 200) at a network node (e.g., IMS-AS 408). In some implementations, one or more process blocks of FIG. 6 are performed by another device or a group of devices separate from or including the apparatus. Additionally, or alternatively, one or more process blocks of FIG. 6 may be performed by one or more components of apparatus 200, such as processor 210, memory 215, storage component 220, input component 225, output component 230, communication interface 235, or communication manager 240.

As shown in FIG. 6, process 600 may include receiving, from a first user equipment, an initial session description protocol offer comprising session description protocol information corresponding to a multimedia call session between the first user equipment and a second user equipment, the initial session description protocol offer indicating media description information associated with the multimedia call session (block 610). For example, the apparatus may receive, from a first user equipment, an initial session description protocol offer comprising session description protocol information corresponding to a multimedia call session between the first user equipment and a second user equipment, the initial session description protocol offer indicating media description information associated with the multimedia call session, as described above.

As further shown in FIG. 6, process 600 may include transmitting a data channel resource request that indicates the media description information (block 620). For example, the apparatus may transmit a data channel resource request that indicates the media description information, as described above.

Process 600 may include additional implementations, such as any single implementation or any combination of implementations described below and/or in connection with one or more other processes described elsewhere herein.

In some aspects, process 600 includes identifying a data channel server instance based at least in part on performing a data channel server discovery process.

With respect to process 600, in some aspects, performing the data channel server discovery process comprises receiving an indication of the data channel server instance from a network repository function.

With respect to process 600, in some aspects, the network repository function comprises a network function profile associated with the internet protocol multimedia subsystem.

In some aspects, process 600 includes facilitating data channel application data traffic routing based at least in part on the network function profile.

With respect to process 600, in some aspects, facilitating data channel application data traffic routing comprises facilitating routing the data channel application data traffic between the data channel server instance and a media resource function controller that includes a service-based interface with the at least one data channel.

With respect to process 600, in some aspects, facilitating data channel application data traffic routing comprises facilitating routing the data channel application data traffic between the data channel server instance and a network exposure function that includes a service-based interface with the at least one data channel.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:

Aspect 1: A method of communication performed by an apparatus at a network node, comprising: receiving a data channel resource request comprising session description protocol information corresponding to a multimedia call session between a first user equipment and a second user equipment, the data channel resource request indicating media description information associated with the multimedia call session; allocating, based at least in part on the session description protocol information, data channel resources corresponding to at least one data channel and associated with the first user equipment and the second user equipment; and providing, using the at least one data channel, a first data channel application to the first user equipment and a second data channel application to the second user equipment.

Aspect 2: The method of Aspect 1, wherein the data channel resources comprise at least one bearer.

Aspect 3: The method of Aspect 2, wherein the at least one bearer comprises at least one of a datagram transport layer security protocol bearer or a stream control transmission protocol bearer.

Aspect 4: The method of any of Aspects 1-3, further comprising: receiving at least one of the first data channel application or the second data channel application; and storing the at least one of the first data channel application or the second data channel application in a data channel application repository.

Aspect 5: The method of any of Aspects 1-3, further comprising retrieving at least one of the first data channel application or the second data channel application from a data channel application repository.

Aspect 6: The method of any of Aspects 1-3, further comprising providing, using the data channel, a data channel application update to at least one of the first user equipment or the second user equipment.

Aspect 7: The method of any of Aspects 1-3, further comprising routing data channel application traffic, associated with at least one of the first data channel application or the second data channel application, between at least one of the first user equipment or the second user equipment and at least one application server instance.

Aspect 8: The method of any of Aspects 1-3, further comprising generating one or more reports that indicate at least one parameter value, wherein the at least one parameter value corresponds to at least one of usage traffic associated with at least one of: the first data channel application or the second data channel application, or an occurrence of an event associated with the data channel application.

Aspect 9: A method of communication performed by an apparatus at a network node, comprising: receiving, from a first user equipment, an initial session description protocol offer comprising session description protocol information corresponding to a multimedia call session between the first user equipment and a second user equipment, the initial session description protocol offer indicating media description information associated with the multimedia call session; and transmitting a data channel resource request that indicates the media description information.

Aspect 10: The method of Aspect 9, further comprising identifying a data channel server instance based at least in part on performing a data channel server discovery process.

Aspect 11: The method of Aspect 10, wherein performing the data channel server discovery process comprises receiving an indication of the data channel server instance from a network repository function.

Aspect 12: The method of Aspect 11, wherein the network repository function comprises a network function profile associated with an internet protocol multimedia subsystem.

Aspect 13: The method of Aspect 12, further comprising facilitating data channel application data traffic routing based at least in part on the network function profile.

Aspect 14: The method of Aspect 13, wherein facilitating data channel application data traffic routing comprises facilitating routing the data channel application data traffic between the data channel server instance and a media resource function controller that includes a service-based interface with at least one data channel.

Aspect 15: The method of either of Aspects 13 or 14, wherein facilitating data channel application data traffic routing comprises facilitating routing the data channel application data traffic between the data channel server instance and a network exposure function that includes a service-based interface with at least one data channel.

Aspect 16: An apparatus for wireless communication at a device, comprising a processor; memory coupled with the processor; and instructions stored in the memory and executable by the processor to cause the apparatus to perform the method of one or more of Aspects 1-8.

Aspect 17: A device for wireless communication, comprising a memory and one or more processors coupled to the memory, the one or more processors configured to perform the method of one or more of Aspects 1-8.

Aspect 18: An apparatus for wireless communication, comprising at least one means for performing the method of one or more of Aspects 1-8.

Aspect 19: A non-transitory computer-readable medium storing code for wireless communication, the code comprising instructions executable by a processor to perform the method of one or more of Aspects 1-8.

Aspect 20: A non-transitory computer-readable medium storing a set of instructions for wireless communication, the set of instructions comprising one or more instructions that, when executed by one or more processors of a device, cause the device to perform the method of one or more of Aspects 1-8.

Aspect 21: An apparatus for wireless communication at a device, comprising a processor; memory coupled with the processor; and instructions stored in the memory and executable by the processor to cause the apparatus to perform the method of one or more of Aspects 9-15.

Aspect 22: A device for wireless communication, comprising a memory and one or more processors coupled to the memory, the one or more processors configured to perform the method of one or more of Aspects 9-15.

Aspect 23: An apparatus for wireless communication, comprising at least one means for performing the method of one or more of Aspects 9-15.

Aspect 24: A non-transitory computer-readable medium storing code for wireless communication, the code comprising instructions executable by a processor to perform the method of one or more of Aspects 9-15.

Aspect 25: A non-transitory computer-readable medium storing a set of instructions for wireless communication, the set of instructions comprising one or more instructions that, when executed by one or more processors of a device, cause the device to perform the method of one or more of Aspects 9-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a network node, comprising:
a memory; and
one or more processors, coupled to the memory, configured to:
receive a data channel resource request comprising session description protocol information corresponding to a multimedia call session between a first user equipment and a second user equipment, the data channel resource request indicating media description information associated with the multimedia call session;
allocate, based at least in part on the session description protocol information, data channel resources corresponding to at least one data channel and associated with the first user equipment and the second user equipment; and
provide, using the at least one data channel, a first data channel application to the first user equipment and a second data channel application to the second user equipment.

2. The apparatus of claim 1, wherein the data channel resources comprise at least one bearer.

3. The apparatus of claim 2, wherein the at least one bearer comprises at least one of a datagram transport layer security protocol bearer or a stream control transmission protocol bearer.

4. The apparatus of claim 1, wherein the one or more processors are further configured to:
receive at least one of the first data channel application or the second data channel application; and
store the at least one of the first data channel application or the second data channel application in a data channel application repository.

5. The apparatus of claim 1, wherein the one or more processors are further configured to retrieve at least one of the first data channel application or the second data channel application from a data channel application repository.

6. The apparatus of claim 1, wherein the one or more processors are further configured to provide, using the data channel, a data channel application update to at least one of the first user equipment or the second user equipment.

7. The apparatus of claim 1, wherein the one or more processors are further configured to route data channel application traffic, associated with at least one of the first data channel application or the second data channel application, between at least one of the first user equipment or the second user equipment and at least one application server instance.

8. The apparatus of claim 1, wherein the one or more processors are further configured to generate one or more reports that indicate at least one parameter value, wherein the at least one parameter value corresponds to at least one of usage traffic associated with at least one of:
the first data channel application or the second data channel application, or
an occurrence of an event associated with the data channel application.

9. An apparatus for wireless communication at a network node, comprising:
a memory; and
one or more processors, coupled to the memory, configured to:
receive, from a first user equipment, an initial session description protocol offer comprising session description protocol information corresponding to a multimedia call session between the first user equipment and a second user equipment, the initial session description protocol offer indicating media description information associated with the multimedia call session; and
transmit a data channel resource request that indicates the media description information.

10. The apparatus of claim 9, wherein the one or more processors are further configured to identify a data channel server instance based at least in part on performing a data channel server discovery process.

11. The apparatus of claim 10, wherein the one or more processors, to perform the data channel server discovery process, are configured to receive an indication of the data channel server instance from a network repository function.

12. The apparatus of claim 11, wherein the network repository function comprises a network function profile associated with an internet protocol multimedia subsystem.

13. The apparatus of claim 12, wherein the one or more processors are further configured to facilitate data channel application data traffic routing based at least in part on the network function profile.

14. The apparatus of claim 13, wherein the one or more processors, to facilitate data channel application data traffic routing, are configured to facilitate routing the data channel application data traffic between the data channel server instance and a media resource function controller that includes a service-based interface with at least one data channel.

15. The apparatus of claim 13, wherein the one or more processors, to facilitate data channel application data traffic routing, are configured to facilitate routing the data channel application data traffic between the data channel server instance and a network exposure function that includes a service-based interface with at least one data channel.

16. A method of communication performed by an apparatus at a network node, comprising:
receiving a data channel resource request comprising session description protocol information corresponding to a multimedia call session between a first user equipment and a second user equipment, the data channel resource request indicating media description information associated with the multimedia call session;
allocating, based at least in part on the session description protocol information, data channel resources corresponding to at least one data channel and associated with the first user equipment and the second user equipment; and
providing, using the at least one data channel, a first data channel application to the first user equipment and a second data channel application to the second user equipment.

17. The method of claim 16, wherein the data channel resources comprise at least one bearer.

18. The method of claim 17, wherein the at least one bearer comprises at least one of a datagram transport layer security protocol bearer or a stream control transmission protocol bearer.

19. The method of claim 16, further comprising:
receiving at least one of the first data channel application or the second data channel application; and
storing the at least one of the first data channel application or the second data channel application in a data channel application repository.

20. The method of claim 16, further comprising retrieving at least one of the first data channel application or the second data channel application from a data channel application repository.

21. The method of claim 16, further comprising providing, using the data channel, a data channel application update to at least one of the first user equipment or the second user equipment.

22. The method of claim 16, further comprising routing data channel application traffic, associated with at least one of the first data channel application or the second data channel application, between at least one of the first user equipment or the second user equipment and at least one application server instance.

23. The method of claim 16, further comprising generating one or more reports that indicate at least one parameter value, wherein the at least one parameter value corresponds to at least one of usage traffic associated with at least one of:
the first data channel application or the second data channel application, or
an occurrence of an event associated with the data channel application.

24. A method of communication performed by an apparatus at a network node, comprising:
receiving, from a first user equipment, an initial session description protocol offer comprising session description protocol information corresponding to a multimedia call session between the first user equipment and a second user equipment, the initial session description protocol offer indicating media description information associated with the multimedia call session; and
transmitting a data channel resource request that indicates the media description information.

25. The method of claim 24, further comprising identifying a data channel server instance based at least in part on performing a data channel server discovery process.

26. The method of claim 25, wherein performing the data channel server discovery process comprises receiving an indication of the data channel server instance from a network repository function.

27. The method of claim 26, wherein the network repository function comprises a network function profile associated with an internet protocol multimedia subsystem.

28. The method of claim 27, further comprising facilitating data channel application data traffic routing based at least in part on the network function profile.

29. The method of claim 28, wherein facilitating data channel application data traffic routing comprises facilitating routing the data channel application data traffic between the data channel server instance and a media resource function controller that includes a service-based interface with at least one data channel.

30. The method of claim 28, wherein facilitating data channel application data traffic routing comprises facilitating routing the data channel application data traffic between the data channel server instance and a network exposure function that includes a service-based interface with at least one data channel.
